(19) United States
(12) Patent Application Publication
(10) Pub. No.: US 2025/0226673 A1
(43) Pub. Date: Jul. 10, 2025

(54) BATTERY PACKAGE AND SYSTEM

(71) Applicant: Infineon Technologies AG, Neubiberg, DE (US)

(72) Inventor: Yow Hing Wong, Singapore (SG)

(21) Appl. No.: 19/002,126

(22) Filed: Dec. 26, 2024

(30) Foreign Application Priority Data
Jan. 5, 2024 (DE) 102024100270.0

(51) Int. Cl. H02J 7/00; H01M 10/42; H04B 5/43; H04W 12/06

(52) U.S. Cl. CPC H02J 7/00045; H01M 10/4221; H01M 10/425; H04B 5/43; H04W 12/06; H01M 2010/4278

(57) ABSTRACT

A battery package is provided. The battery package includes a battery, at least one terminal coupled to an antenna, a single wire interface configured to communicate with a processor and coupled to the at least one terminal, a battery authentication circuit arranged on the battery, a choke inductor coupled to the single wire interface, and a clamping transistor circuit including a clamping transistor and coupled to the choke inductor and configured to clamp a voltage applied to the single wire interface to an operating voltage of the battery authentication circuit.

### TECHNICAL FIELD

Various embodiments relate generally to a battery package and to a system.

### BACKGROUND

Some battery packages of mobile devices that are equipped with a wireless communication circuit (for example for near field communication, NFC) may additionally include a battery authentication circuit for ensuring that only an approved/authenticated battery is installed in the mobile device.

For providing power to the authentication circuit and/or for communication with the authentication circuit, one or more pins in addition to the regular four pins are provided. This leads to a compatibility problem, in that only mobile devices that are configured to connect also to the additional pins may be provided with the battery with the authentication circuit.

### SUMMARY

A battery package is provided. The battery package includes a battery, at least one terminal coupled to an antenna, a single wire interface configured to communicate with a processor and coupled to the at least one terminal, a battery authentication circuit arranged on the battery, a choke inductor coupled to the single wire interface, and a clamping transistor circuit including a clamping transistor and coupled to the choke inductor and configured to clamp a voltage applied to the single wire interface to an operating voltage of the battery authentication circuit.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic circuitry of a system in accordance with various embodiments that includes a battery package in accordance with various embodiments;

FIG. 2 shows a visualization of input ramp up voltage versus output voltage level during an operation of the battery package of various embodiments;

FIG. 3 shows results of a pulse test at 100 Kbps during an operation of the battery package of various embodiments in authentication mode;

FIG. 4 visualizes input and output of Single Wire Interface (SWI) signals during an operation of the battery package of various embodiments in authentication mode;

FIG. 5 visualizes voltages and currents encountered in the battery package in accordance with various embodiments during an operation in NFC mode with a 13.56 MHz input signal (top) and a 16 MHz input signal (bottom), respectively; and

FIG. 6 illustrates an effect of the low pass filter circuit on the output voltage in the battery package in accordance with various embodiments.

### DETAILED DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Various aspects of the disclosure are provided for devices, and various aspects of the disclosure are provided for methods. It will be understood that basic properties of the devices also hold for the methods and vice versa. Therefore, for sake of brevity, duplicate description of such properties may have been omitted.

Systems like for example mobile devices may include battery packages that are equipped with a wireless communication circuit (for example for near field communication, NFC; for example the antenna may be arranged on or in the battery package) may additionally include a battery authentication circuit for ensuring that only an approved/authenticated battery is installed in the system (e.g., the mobile device).

However, a battery package has multiple interfaces and typically four (e.g., pins or contact surfaces) that provide access to the battery package, and in particular to the antenna for the wireless (e.g., NFC) communication.

In various embodiments, an interface that is used for the wireless communication (e.g., for a connection to the antenna) is reused for battery authentication in addition to the wireless communication.

The embodiments address the challenges of high frequency and high voltages.

Additional circuit portions are provided in the battery package for low pass filtering and for clamping a voltage at the interface to an operating voltage of the battery authentication circuit.

The additional circuit components are four low-cost components that ensure excellent high voltage protection and isolation. The additional circuit components include a choke inductor and a clamping transistor. Optionally, a low-pass filter may additionally be provided.

The interface may be multiplexed (for example, as a multiplex SWI bus) and shared with the NFC front end. Compatibility issues of the prior art, which limit the usability of the battery package to certain host systems that are provided with compatible extra interfaces are avoided.

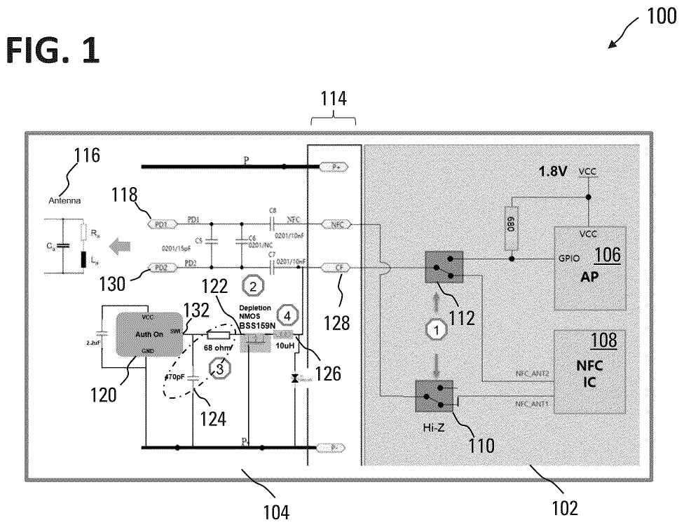

FIG. 1 shows a schematic circuitry of a system 100 in accordance with various embodiments that includes a battery package 104 in accordance with various embodiments. Numbers 1 to 4 that are added in FIG. 1 indicate the newly added circuit components.

The system 100 may for example be configured as a mobile wireless device like for example a smartphone. The system 100 may include a host system 102 that may for example correspond to the system 100 without the battery package 104, but may be configured to receive a battery package 104. The host system 102 may include a processor 106, for example an application processor. The host system 102 may further include an NFC frontend 108 for contactless communication.

The processor 106 and the NFC frontend 108 may largely be configured as known in the art, with the exception of being configured to operate at least one multiplexing component containing analog switches 110, 112 (marked with “1” in FIG. 1) that may be provided in the system 100, e.g., in the host system 102. FIG. 1 shows the switches 110, 112 as two individual analog switches. The switches 110, 112 may in various embodiments be configured to be operated jointly, in other words, to both be either in a position configured to enable communication (also referred to as communication mode, NFC mode or normal mode) or to both be in a position configured to enable authentication (also referred to as battery authentication (BA) mode or authentication mode for short).

When in battery authentication mode, the switches 110, 112 will enable single wire interface (SWI) communication over an interface 128 that is configured to be connected the to the authentication circuit 120 via the application processor 106 GPIO terminal, and isolate the communication processor 108 (also referred to as NFC frontend) from the SWI bus to prevent loading.

The battery package 104 includes a battery (not shown), at least one terminal 130 to be coupled to an antenna 116 (an additional terminal 118 to be coupled to the antenna 116 may additionally be provided in the battery package 104), and an interface 128 configured to communicate with the processor 106 and coupled to the at least one terminal 130. The interface 128 may be one interface of a group of interfaces 114, in this exemplary embodiment four interfaces, that may be arranged and configured to be compatible with a wide range of host systems 102.

The battery system 104 further includes a battery authentication circuit 120 arranged on the battery, a choke inductor 126 (additionally marked with “4” in FIG. 1) coupled to the interface 128, and a clamping transistor circuit 122 (additionally marked with “2” in FIG. 1) coupled to the choke inductor 126 and configured to clamp a voltage applied to the interface 128 to an operating voltage of the battery authentication circuit 120.

The antenna 116 coupled to the terminal 130 (and to the additional terminal 118) may in various embodiments be part of the battery package 104. The antenna 116 may for example be configured for near field communication (NFC), for example at a communication frequency of 13.56 MHz. The additional terminal 118 may be coupled to an interface (other than the single wire interface 128) of the group of four interfaces 114.

In various embodiments, the battery package 104 may further include a low pass filter circuit 124 (additionally marked with “3” in FIG. 1) coupled between the clamping transistor circuit (e.g., the clamping transistor 122) and the battery authentication circuit. The low pass filter circuit 124 includes a resistor and a capacitor connected in parallel between the clamping transistor circuit 122 and an interface 114 (a yet further interface of the group of interfaces 114) to a negative or ground potential.

In various embodiments, for example as shown in FIG. 1, the clamping transistor 122 is a depletion NMOS transistor.

The clamping transistor 122 may be coupled between the interface 114 to the negative or ground potential and the choke inductor 126.

In the embodiment with the clamping transistor 122 coupled to the negative or ground potential, e.g., as in FIG. 1, the clamping transistor 122 may be a depletion NMOS transistor.

The operating voltage of the authentication circuit 120, to which the voltage applied to the interface 128 is clamped, may be in a range from about 1.24 V to about 3.63 V. If a different type of single wire interface was used, the voltage range could be different.

In other words, for an operating voltage in a range between about 1.24 V and 3.63 V, the clamping transistor 122 may be selected such that voltages below the clamping voltage are simply passed through, and in an occurrence of an over-voltage (e.g., an input voltage Vin above the operating voltage), may limit (clamp) an output voltage Vout at negative V_{GS} (which may for example have a typical value of V_{GSth}=−2.8 V for the depletion NMOS transistor of the type BSS159, which may result in Vout at 2.8 V).

The low-pass filter circuit 124 may be configured with a cutoff frequency that is significantly below the NFC communication frequency for which the antenna 116 is configured, for example well below 13.56 MHz. The cutoff frequency of the low pass filter may, for example, be set to below 5 MHz. In the exemplary embodiment shown in FIG. 1 the capacitor with a capacity of 470 pF in combination with the resistor with a resistance of 68 Ω may provide a cutoff frequency of f_{-3dB}=4.98 MHz. This cut off frequency may be adjusted to allow a peak data rate of the SWI bus 132 communication of the authentication circuit 120 in this exemplary maximum at about 166 Kbps for bus power mode operation.

The low-pass filter circuit 124 may serve to reduce the high frequency component and amplitude at 13.56 MHz and above. The low-pass filter circuit 124 may serve as a time averaging circuit to ensure the battery authentication circuit 120 is protected from negative voltage swing in NFC mode when NFC signals (input voltages Vin) that might swing down to negative voltage level at the SWI bus 132 may damage the authentication circuit 120.

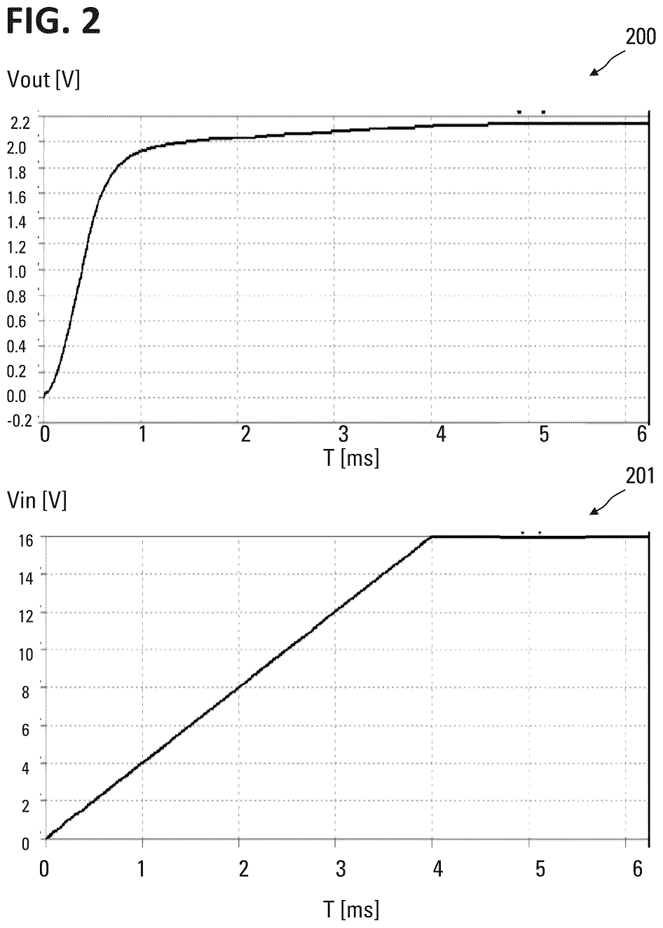

FIG. 2 shows a visualization 200 of circuit characteristics of test input voltage Vin at the interface 128 and the corresponding output voltage Vout at the SWI bus 132 of the battery package 104 of various embodiments.

The test input voltage Vin provided at the interface 128 ramps up from 0 to 16V, but the output voltage is limited at 2.2V maximum at the SWI bus 132. Therefore the battery authentication circuit 120 is protected from high voltage swing during NFC communication mode.

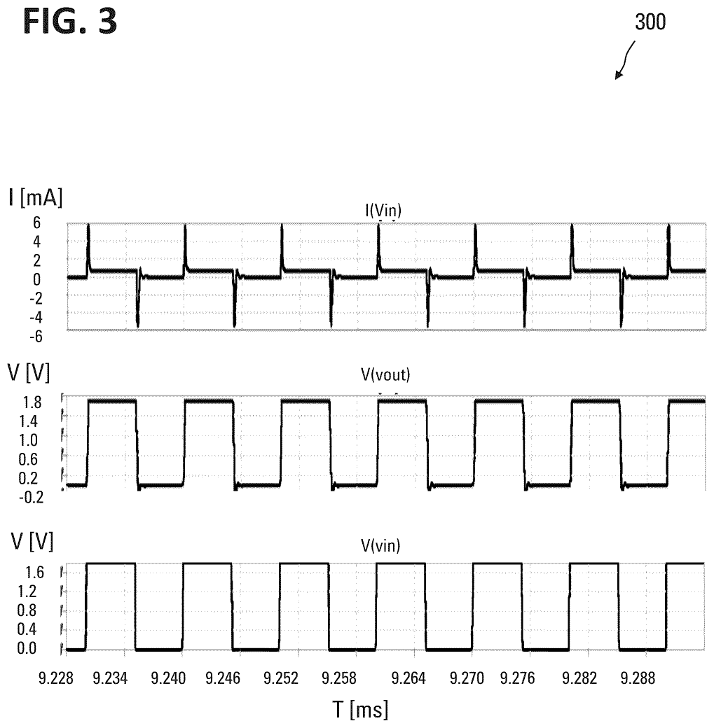

FIG. 3 shows results 300 of a pulse test at 100 Kbps during an operation of the battery package 104 of various embodiments in authentication mode.

In FIG. 3, in particular a comparison of Vin at the interface 128 versus Vout at the SWI bus 132 shows that the signals pass through as intended during battery authentication mode when the input signal Vin at the interface 128 is at 1.8V.

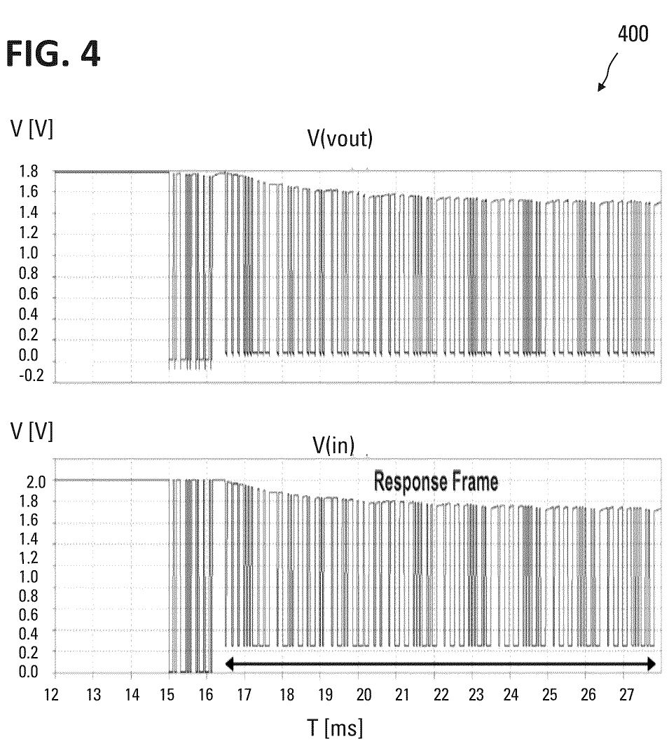

FIG. 4 visualizes, in panel 400, SWI command input signals Vin at interface 128 and output signals Vout at the SWI bus 132 during an operation of the battery package 104 of various embodiments in authentication mode.

FIG. 4 demonstrates that, under battery authentication (BA) mode, the data pulses at the interface 128 (SWI command data pulses) are passed through and working as intended.

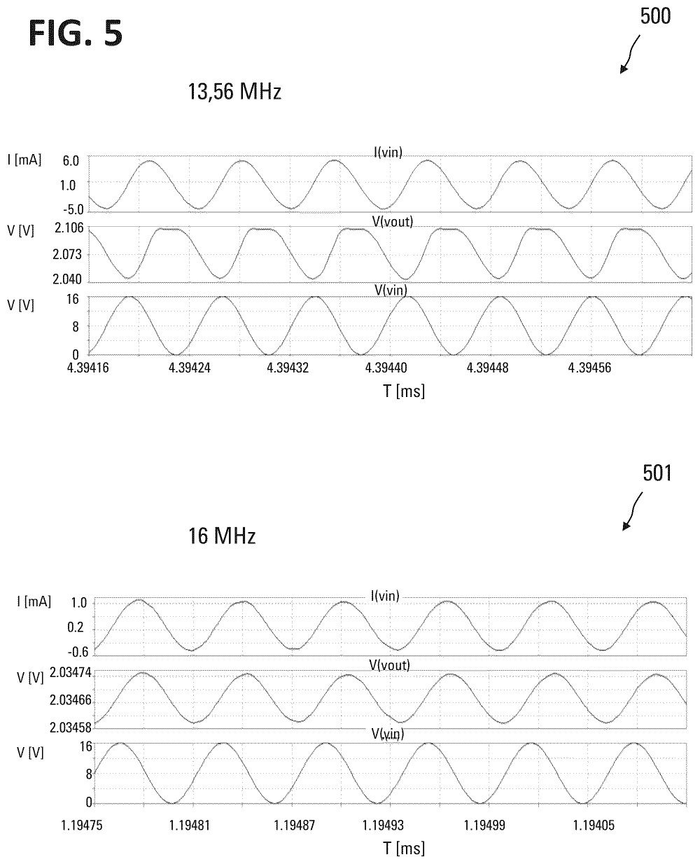

FIG. 5 visualizes voltages and currents encountered in the battery package 104 in accordance with various embodiments during an operation in NFC mode with an 13.56 MHz input test signal (panel 500) and an 16 MHz input test signal (panel 501), respectively.

FIG. 5 demonstrates that both, 13.56 Mhz and 16 MHz modes high voltage test signals are reduced to a maximum voltage level of <2.1V. This means that a device connected to the Vout (e.g., the battery authentication circuit 120) will be protected from high voltage NFC signal.

On a side note, a circuit power consumption may, in the exemplary embodiment of FIG. 1, be in a mW range between about 5 mW and about 30 mW under 13.56 Mhz to 16 Mhz and 0 to 16 V test Sine wave signals conditions. This power consumption may be negligible compared to an amount of power in a range of about 1 to 2 W that may typically be generated by an NFC front end and hence exhibit minimum loading condition during the NFC mode.

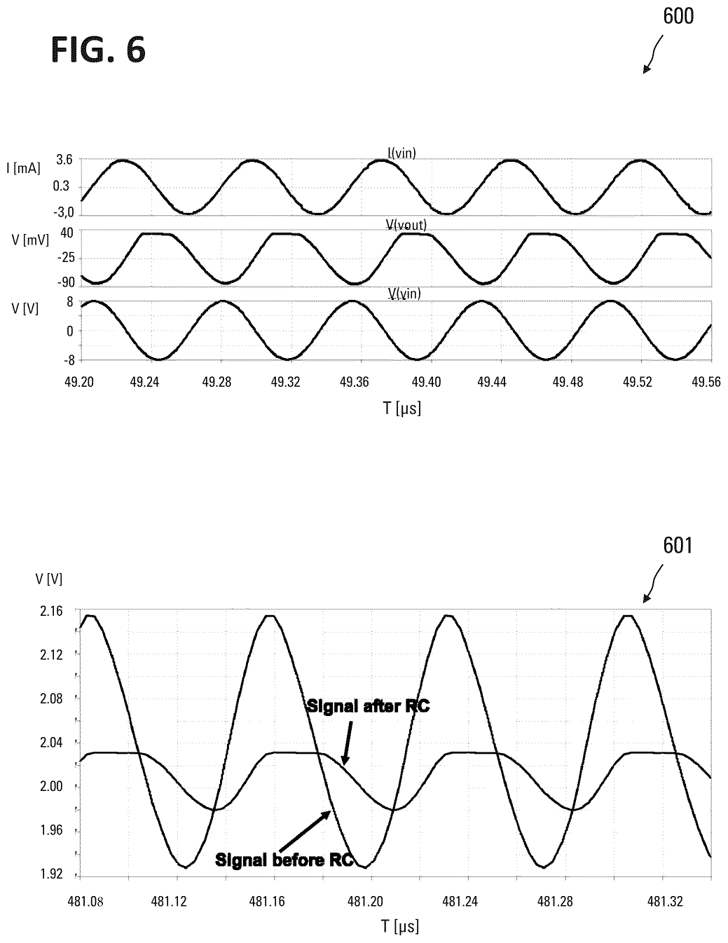

FIG. 6 illustrates, in panel 601, the characteristic of the low pass filter circuit 124 on the output voltage Vout at the SWI bus 132 in the battery package 104 in accordance with various embodiments.

FIG. 6 illustrates, in pannel 600, the output voltage Vout at the SWI bus 132 is between −90 mV to +40 mV when a full swing test signal with +8 V and −8 V applied to input at the interface 128. The output voltage at the SWI bus 132 shows that the battery authentication circuit 120 will be protected from negative swing of voltage. In a real application, a reader front end may have under shoot of for example down to −2 V, so in such cases, the circuit, for example in particular the choke inductor 126, the clamping transistor 122 (e.g., the depletion NMOS transistor), and the low pass filter circuit 124, will ensure that the battery authentication circuit 120 will not be damaged by negative Vout below −0.3 V absolute maximum.

Various examples will be illustrated in the following:

Example 1 is a battery package. The battery package includes a battery, at least one terminal to be coupled to an antenna, a single wire interface configured to communicate with a processor and coupled to the at least one terminal, a battery authentication circuit arranged on the battery, a choke inductor coupled to the single wire interface, and a clamping transistor circuit comprising a clamping transistor and coupled to the choke inductor and configured to clamp a voltage applied to the single wire interface to an operating voltage of the battery authentication circuit.

In Example 2, the subject-matter of Example 1 mayfurther include a low pass filter circuit coupled between the clamping transistor circuit and the battery authentication circuit.

In Example 3, the subject matter of Example 1 or 2 may further include that the battery package is operable in a Near Field Communication (NFC) mode of providing communication signals at the at least one terminal, wherein, in NFC mode, the voltage applied to the single wire interface is clamped, and may still further include that the battery package is operable in a Battery Authentication mode, in which command signals provided at the single wire interface are passed through.

In Example 4, the subject-matter of any of Examples 1 to 3 may further include an antenna coupled to the at least one terminal, further optionally including a matching circuit connected to the antenna.

In Example 5, the subject-matter of Example 3 may include that the antenna is a near field communication (NFC) antenna.

In Example 6, the subject-matter of any of Examples 1 to 5 may include that the clamping transistor is a depletion NMOS transistor.

In Example 7, the subject-matter of any of Examples 1 to 6 may include that the clamping transistor is coupled between an interface to a negative or ground potential and the choke inductor.

In Example 8, the subject-matter of any of Examples 1 to 7 may include that the battery package includes a total of (e.g., exactly) four interfaces including the single wire interface.

In Example 9, the subject-matter of any of Examples 1 to 8 may include that the operating voltage of the authentication circuit is in a range from about 1.24 V to about 3.63 V.

In Example 10, the subject-matter of any of Examples 2 to 9 may include that the low pass filter circuit includes a resistor and a capacitor connected in series between the clamping transistor circuit and an interface a negative or ground potential.

In Example 11, the subject-matter of any of Examples 2 to 10 may include that a cutoff frequency of the low pass filter is below 5 MHz.

In Example 12, the subject-matter of any of Examples 1 to 11 may include that the choke inductor is configured to isolate an NFC communication signal received at the terminal from the antenna.

Example 13 is a system. The system includes a battery package of any one of Examples 1 to 12 and a processor couplable (i.e., capable of being coupled) to the single wire interface and configured to communicate with the battery authentication circuit.

In Example 14, the subject-matter of Example 13 may further include an NFC frontend circuit configured for NFC wireless communication using the antenna.

In Example 15, the subject-matter of Example 13 or 14 may optionally further include at least one switch, wherein the processor is couplable to the single wire interface by the at least one switch.

In Example 16, the subject-matter of Example 15 may optionally further include the at least one switch is configured to connect either the processor or the communication circuit to the single wire interface.

In Example 17, the subject-matter of any of Examples 13 to 16 may include that the system is configured as a mobile device, for example a mobile communication device, e.g. a smartphone.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

what is claimed is:

1. A battery package, comprising:
a battery;
at least one terminal configured to be coupled to an antenna;
a single wire interface configured to communicate with a processor and coupled to the at least one terminal;
a battery authentication circuit arranged on the battery;
a choke inductor coupled to the single wire interface; and
a clamping transistor circuit comprising a clamping transistor and coupled to the choke inductor and configured to clamp a voltage applied to the single wire interface to an operating voltage of the battery authentication circuit.

2. The battery package of claim 1, further comprising:
a low pass filter circuit coupled between the clamping transistor circuit and the battery authentication circuit.

3. The battery package of claim 2, wherein the low pass filter includes a resistor and a capacitor connected in series between the clamping transistor circuit and an interface at a negative or ground potential.

4. The battery package of claim 2, wherein a cutoff frequency of the low pass filter is below 5 MHz.

5. The battery package of claim 1, further comprising:
an antenna coupled to the at least one terminal.

6. The battery package of claim 5, wherein the antenna is a near field communication antenna.

7. The battery package of claim 1, wherein the clamping transistor is a depletion NMOS transistor.

8. The battery package of claim 1, wherein the clamping transistor is coupled between an interface to a negative or ground potential and the choke inductor.

9. The battery package of claim 1, wherein the battery package has a total of four interfaces including the single wire interface.

10. The battery package of claim 1, wherein the operating voltage of the authentication circuit is in a range from about 1.24 V to about 3.63 V.

11. The battery package of claim 1, wherein the choke inductor is configured to isolate an NFC communication signal sent or received at the at least one terminal from the antenna.

12. A system, comprising:
the battery package of claim 1; and
a processor couplable to the single wire interface and configured to communicate with the battery authentication circuit.

13. The system of claim 12, further comprising:
at least one switch configured to couple the processor to the single wire interface.

14. The system of claim 12, further comprising:
a wireless communication circuit couplable to the single wire interface and configured for wireless communication using the antenna.

15. The system of claim 14, further comprising:
at least one switch configured to couple the wireless communication circuit to the single wire interface.
